(19) United States
(12) Patent Application Publication
(10) Pub. No.: US 2008/0029529 A1
(43) Pub. Date: Feb. 7, 2008

(54) Theft-deterring lock protectors

(76) Inventor: Gary Ruhl, Oshkosh, WI (US)

Correspondence Address: WILHELM LAW SERVICE, S.C., 100 W LAWRENCE ST, THIRD FLOOR, APPLETON, WI, 54911, US

(21) Appl. No.: 11/888,259

(22) Filed: Jul. 31, 2007

Related U.S. Application Data
(60) Provisional application No. 60/835,792, filed on Aug. 4, 2006.

(51) Int. Cl. E05B 67/38; B65D 90/00

(52) U.S. Cl. 220/890; 70/431; 70/56

(57) ABSTRACT

Theft-deterrent lock protector apparatus generally encloses and mechanically restricts access to locks which restrict access to receptacles, containers, and/or materials of value, thus providing a second level of security to such receptacles, containers, and/or materials. Such receptacles, containers, and materials include shipping containers, truck bodies, enclosed trailers, and hitch receptacles. Such locks include padlocks, shackle locks, U-locks, hasps, trailer latches, trailer clasps, trailer tongues, receiver hitches, and receiver pins. The locking enclosure apparatus restriction enables a user to secure various objects with such locks and lock protectors while mitigating deleterious and/or nefarious tool access to the locks themselves.

### BACKGROUND

This invention relates generally to theft deterring devices and/or padlock or other lock protecting devices. In general, it is common practice to apply a padlock or other lock device to containers or receptacles which contain valuable goods, valuable information, or valuable operational capabilities. Thus it is common to apply a lock to the containment structure on e.g. a truck, trailer, or other receptacle. It is also common to apply a lock to a towing structure of a truck or trailer.

As an example of such lock, there can be mentioned a padlock. A padlock has a lock body, which is typically quite difficult to destroy, and a shackle which extends from the lock body. The shackle is generally made from a hardened steel rod. A common such shackle extends from the lock body in a loop, to an end of the shackle. When the lock is locked in securing a device, typically two or more elements are passed through the loop defined by the shackle, thus securing the two or more elements in a defined cooperating configuration which prevents access to the structure which is being protected.

When the lock is opened, such as by employing a key in the lock body, the end of the shackle is released from the lock body, and the shackle can be rotated so as to release, from the shackle, the two or more elements which had been locked together by the lock body.

In a typical padlock, the lock body is substantially more robust than the lock shackle. Accordingly, anyone desiring to commit a nefarious act, such as breaking the lock to gain access to the protected material, addresses such attention to the shackle. In general, a padlock shackle can be readily cut by a manually-operated bolt cutter. The larger and more robust the padlock, the larger and more robust is the bolt cutter which is needed to cut the shackle. The nefarious actor merely matches the size of the bolt cutter to the size of the shackle which he/she expects to encounter in the lock apparatus. Assuming a sufficiently robust bolt cutter, the lock is readily and quickly cut by manual action, which makes essentially no sound, and whereby the protected material is readily accessed.

Theft of goods and material from protected containers and receptacles is rather widespread, in spite of the conventional practice of applying locks to the material which is to be protected.

Such theft activity is, of course, illegal. Accordingly, it is important that the actors not be caught by the authorities. One of the critical elements of not being caught is the need for speed. Another critical element is the need for quiet, since sound can attract attention. Thus, anything which can be done to increase the time or sound needed to carry out a theft activity is a deterrent to such theft.

As a method of deterring such theft, and making such theft more difficult, the invention adds a secondary protection device to the locking function, which requires an additional step for release of the protective lock from the structure and/or material being protected. In defeating the additional protection device, the would-be thieves must use additional tools. The implementation of such tools requires that additional time be employed at the site of the theft. If manual tools are used, the additional time in defeating the lock/protector system is substantial. Such time can be substantially reduced by using power-driven tools, but with the addition of substantially more sound.

In particular, the present invention mechanically restricts access to e.g. a padlock, shackle lock, other lock, hasp, trailer latch, trailer clasp, trailer tongue, receiver hitch, hitch or receiver pin, as desired. Correspondingly, the present invention deters theft of objects, articles, and or items which are typically secured, at least in part by, for example, a padlock or other suitable lock.

Padlocks are used in a variety of industries or applications to secure or lock various object, articles, or items, for example a variety of trailer and towing related accessories. The trucking industry, for example, uses padlocks for a variety of securing or locking tasks.

As one example, some transportation and shipping industry vessels and containers, such as cargo and shipping containers, use cam lock style door closure and locking mechanisms, which are secured with ancillary padlocks, shackle locks, and/or other locks.

The typical cargo or shipping container has a pair of hinged and pivoting, opposing, doors mounted so as to collectively close an opening from the surrounding environment. A typical container cam lock has an actuatable locking arm and a lock clasp which is, for example, a finger like projection or bracket. In the locked configuration of a container cam lock, the lock clasp is adjacent an end portion of the locking arm. Such configuration enables a user to pass a padlock or shackle lock through aligned holes in the hasp and handle keeper, whereby the hasp and handle keeper are locked to each other, thereby to retain the handle at a fixed disposition. Absent the invention, when one is using a container cam lock, the padlock, shackle lock, or other lock, remains exposed and vulnerable to destruction, tampering, or other damaging or other undesired meddling.

Certain embodiments of commercially-available truck semi-trailers have two trailer doors, mounted to the trailer on hinges which pivot about generally upright axes. The doors on such semi-trailers are commonly referred to as “swing out doors”. When such swing-out doors are closed, an e.g. cam lock mechanism, which is generally an analog of the above described container cam lock mechanism, is engaged. A typical trailer cam lock has an actuatable handle, a hasp, and a handle keeper bracket. In the locked state of a trailer cam lock, the hasp and handle keeper bracket envelope a portion of the handle. This configuration enables a user to pass a padlock or shackle lock through aligned holes in the hasp and handle keeper, whereby the hasp and handle keeper are locked to each other and retain the handle in a fixed position. When using a trailer cam lock, the padlock, shackle lock, or other lock, remains exposed and vulnerable to destruction, tampering, or other meddling.

Other typical semi-trailers, and some e.g. enclosed cargo compartment trucks, have lift-type doors in lieu of swing out doors. Such doors typically include a hook-type latch mechanism. Such hook-type latch mechanisms include a pivotable member, which includes both an arcuate portion and a handle portion, and a latch finger. To secure the door in its downward, closed, position, the user pivots the handle downwardly so that the end of the handle portion is adjacent the latch finger. Then the user locks the handle portion to the latch finger by way of e.g. a padlock, a shackle lock, and/or other suitable lock. When using such a hook-type latch, the padlock, shackle lock, or other lock, remains exposed and vulnerable to destruction, tampering, or other meddling.

Many non-semi trailers, for example various enclosed snowmobile trailers, recreational vehicle trailers, utility trailers, and/or other trailers, include conventional hasp locks, and/or other hardware or devices which enable mechanical locking of the trailer compartment. A conventional hasp lock includes a hinged metal strap with opening therethrough which fits over a staple. Users of such hasp lock equipped trailers hingedly swing the metal strap over the staple, then secure a padlock or shackle lock through the staple, securing the trailer. However, when using a hasp and padlock, shackle lock, or other lock, the lock remains exposed and vulnerable to destruction, tampering, or other meddling.

A variety of trailers, such as utility trailers, boat trailers, campers, car haulers, and/or other trailers utilize ball hitch style coupling devices, to connect the trailer to the tow vehicle. A ball hitch coupler used with such trailers includes a ball receiving cavity and a lever or latch, which enables the user to secure the coupler to the hitch ball. Such couplers are commonly referred to as lever style couplers.

Typically, the lever or latch of the lever style coupler includes a through bore, extending transversely therethrough. The through bore in the lever enables a user to insert, e.g. a pin therethrough which ensures that the lever remains in the downward, locked, position while the trailer is being towed.

The user of a lever style coupler may use a padlock or other lock to secure the lever in the downward, locked, position while the trailer is not being towed. As one example, the trailer coupler can be locked to the tow vehicle. As another example of use of the invention, the trailer can be disconnected from the tow vehicle, with the lever being deployed in the downward, locked, position, and secured by a padlock, whereby the coupler cannot accept a hitch ball therein without first removing the padlock. However, when using a padlock or other lock on a lever style coupler, the lock remains exposed and vulnerable to tampering, meddling, or cutting.

Tow vehicles include any of a variety of vehicles such as passenger cars, sport utility vehicles, light duty trucks, medium duty trucks, heavy trucks, and others. Typical tow vehicles utilize a receiver hitch. A receiver hitch includes a receiver, which is mounted to the vehicle and is sized and configured for a maximum tow rating, and a ball mount. The hitch ball is mounted to the ball mount which is, in turn, held in the receiver while the trainer is being towed.

When the ball mount is not locked into the receiver, the ball mount can be readily removed from the receiver by merely removing the receiver hitch pin, which inserts through aligned holes and secures together the ball mount and the receiver. Accordingly, users of receiver hitches have recognized the utility of locking the ball mount into the receiver, because an unlocked ball mount can be readily removed from its receiver by merely removing the receiver hitch pin. However, typical locks used to secure a receiver and/or ball mount remain exposed and vulnerable, during use, to destruction, tampering, or other meddling.

Thus, towing security or anti-theft devices, conventionally employed in combination with trailers being towed, include an exposed lock of some sort. However, such exposed locks, e.g. shackle locks, padlocks, and others, can be defeated by bolt cutters, other cutting tools, grinders, pry bars, and/or other tools or means to defeat locks.

It is therefore desirable to provide theft deterring lock protectors which generally surround or cover conventional locks, mitigating access thereto by bolt cutters and/or other commonly-used cutting tools.

It is also desirable to provide theft deterring lock protectors which are at least somewhat visually conspicuous, whereby a potential thief can easily see the device from afar, which might possibly dissuade a potential theft.

It is also desirable to provide theft deterring lock protectors which generally surround or cover conventional locks, for a variety of applications, such as for use with semi-trailer doors, non-semi trailer enclosures, lever style tongue couplers, receiver hitch receivers, receiver hitch ball mounts, receiver hitch pins, and/or other towing accessories or hardware.

### SUMMARY OF THE INVENTION

The invention provides lock protectors which generally enclose and mechanically restrict access to, for example, padlocks, shackle locks, U-locks and other locks, hasps, trailer latches, trailer clasps, trailer tongues, receiver hitches, hitches or receiver pins which control access to related containers and/or receptacles of other materials. The mechanical access restriction to respective locks enables a user to secure various objects with such locks while mitigating access to the locks themselves with tools which are capable of destroying the lock.

With the lock protected by protectors of the invention, would-be thieves having only e.g. a bolt cutter capable of cutting the lock shackle are unable to engage the bolt cutter onto the shackle. By thus making it more difficult to gain access to the lock, the theft is made more difficult, more time-consuming, which deters an increased fraction of theft attempts.

In a first family of embodiments, the invention comprehends a lock protector device, comprising one or more sidewalls which collectively define an outer surface, and first and second ends of the lock protector device, and a length of the lock protector device between the first and second ends; and at least a first opening which extends into the first end of the lock protector device and which opens into a cavity extending axially into the lock protector device. The one or more sidewalls defines a limited-size access aperture having a length dimension extending transverse to the length dimension of the lock protector device, and a width dimension substantially smaller than the length dimension of the lock protector device.

In some embodiments, the one or more side walls define a generally closed perimeter of the lock protector device.

In some embodiments, the invention comprehends a lock protector assembly kit comprising the lock protector device, and a lock. The lock has a lock body, and a shackle extending from the lock body. The shackle and the lock protector device are adapted and configured such that the shackle can be received into the cavity in the lock protector device through the first opening which extends into the first end of the lock protector device so as to protect the shackle from effective application of a manually-actuated cutting tool such as a bolt cutter.

In some embodiments, the limited-size access aperture spans at least first and second adjacent ones of the one or more side walls.

In some embodiments, the limited size access aperture comprises a generally circular opening spaced from both of the first and second ends.

In some embodiments, the lock protector device further comprises a second opening which extends into the second end of the lock protector device and which opens into the cavity.

In some embodiments, the invention comprehends a locked receptacle or enclosure, comprising a receptacle closed by closure structure, thereby blocking intended-use access to the receptacle, a lock, the lock comprising a lock body, and a shackle extending from the lock body, the lock locking the closure structure in the closed condition, and a lock protector extending about the lock and interfering with access to the shackle by hand tools commonly useful for defeating a lock shackle.

In a second family of embodiments, the invention comprehends a lock protector device, comprising at least first and second sidewalls, each having a thickness dimension, intersecting at respective edges thereof. The at least first and second sidewalls collectively define an outer surface of the lock protector, and first and second ends of the lock protector, and a length of the lock protector between the first and second ends; and a limited-size access aperture which extends, transverse to the length of the lock protector, across a portion of at least two adjacent ones of the sidewalls, the aperture extending through the entire thickness dimension of the respective at least two adjacent ones of the sidewalls.

In a third family of embodiments, the invention comprehends a lock protector assembly, comprising a lock protector and a lock. The lock protector comprises one or more sidewalls which collectively define a side wall perimeter of the lock protector structure, the lock protector structure being generally closed along the side wall perimeter and having first and second open ends, an aperture extending through at least one of the one or more sidewalls and being displaced from the first end of the enclosure structure by a first distance. The lock has a lock body, and a shackle length dimension extending away from the lock body. The magnitude of the first distance, between the aperture and the first end of the enclosure structure, is greater than the shackle length dimension extending away from the lock body.

In some embodiments, the invention comprehends a locked receptacle, comprising a receptacle closed by closure structure, thereby blocking intended-use access to the receptacle, a lock, and a lock protector. The lock comprises a lock body, and a shackle extending from the lock body. The lock locks such closure structure in such closed condition. The lock protector extends about the lock and interferes with access to the shackle by hand tools commonly useful for defeating such lock shackle.

In a fourth family of embodiments, the invention comprehends a lock protector device, comprising one or more sidewalls which collectively define a lock protector having a sidewall perimeter, the enclosure structure being generally closed along the sidewall perimeter and having at least a first open end; and an aperture extending through at least one of the one or more sidewalls, the aperture extending along a minor portion of a length dimension of a respective sidewall and extending along a minor portion of a width dimension of the respective sidewall.

In some embodiments, the side wall perimeter is defined by a single circular side wall.

### BRIEF DESCRIPTION OF THE DRAWINGS

FIG. 1A illustrates a pictorial view of a first embodiment of lock protectors of the invention, used on a first tractor trailer.

FIG. 1B illustrates a pictorial view of a second embodiment of lock protectors of the invention, used on an enclosed trailer which includes a hasp lock.

FIG. 1C illustrates a pictorial view of a third embodiment of lock protectors of the invention, used on a lock lever of a trailer coupler.

FIG. 1D illustrates a pictorial view of a forth embodiment of lock protectors of the invention, used with a U-lock on a receiver hitch.

FIG. 1E illustrates a pictorial view of a fifth embodiment of lock protectors of the invention, used with a receiver hitch.

FIG. 1F illustrates a pictorial view of a sixth embodiment of lock protectors of the invention, used on a second tractor trailer.

FIG. 1G illustrates a pictorial view of a seventh embodiment of lock protectors of the invention, used on an enclosed utility trailer.

FIG. 1H illustrates a pictorial view of a seventh embodiment of lock protectors of the invention, used on a cargo shipping container.

FIG. 2A illustrates a pictorial, exploded view of the lock protector of FIG. 1A.

FIG. 2B illustrates a pictorial, exploded view of the lock protector of FIG. 1B.

FIG. 2C illustrates a pictorial, exploded view of the lock protector of FIG. 1C.

FIG. 2D illustrates a pictorial, exploded view of the lock protector of FIG. 1D.

FIG. 2E illustrates a pictorial, exploded view of the lock protector of FIG. 1E.

FIG. 2F illustrates a pictorial, exploded view of the lock protector of FIG. 1F.

FIG. 2G illustrates a pictorial, exploded view of the lock protector of FIG. 1G.

FIG. 2H illustrates a pictorial, exploded view of the lock protector of FIG. 1H.

FIG. 3 illustrates an enlarged, pictorial view of a lock protector of the invention.

FIG. 4 illustrates a pictorial view, from above, of the lock protector of FIG. 1B.

The invention is not limited in its application to the details of construction, or to the arrangement of the components set forth in the following description or illustrated in the drawings. The invention is capable of other embodiments or of being practiced or carried out in various other ways. Also, it is to be understood that the terminology and phraseology employed herein is for purpose of description and illustration and should not be regarded as limiting. Like reference numerals are used to indicate like components.

### DETAILED DESCRIPTION OF THE ILLUSTRATED EMBODIMENTS

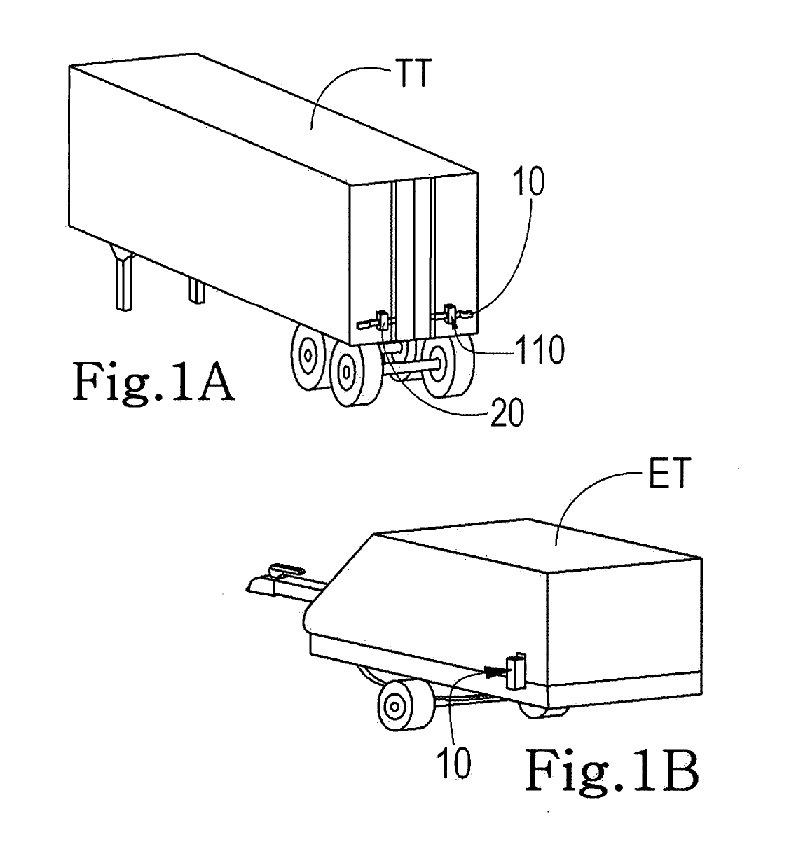

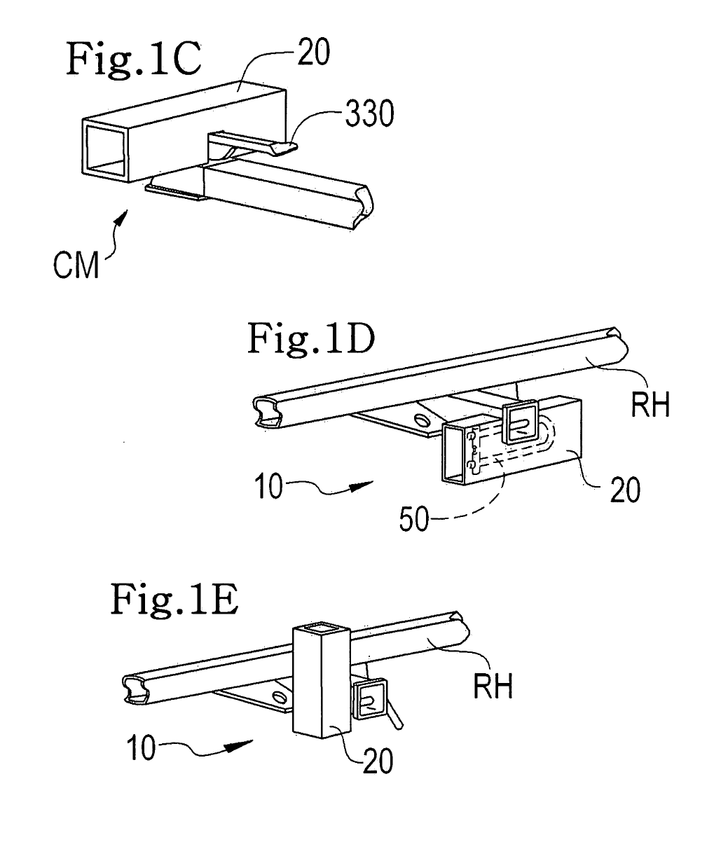

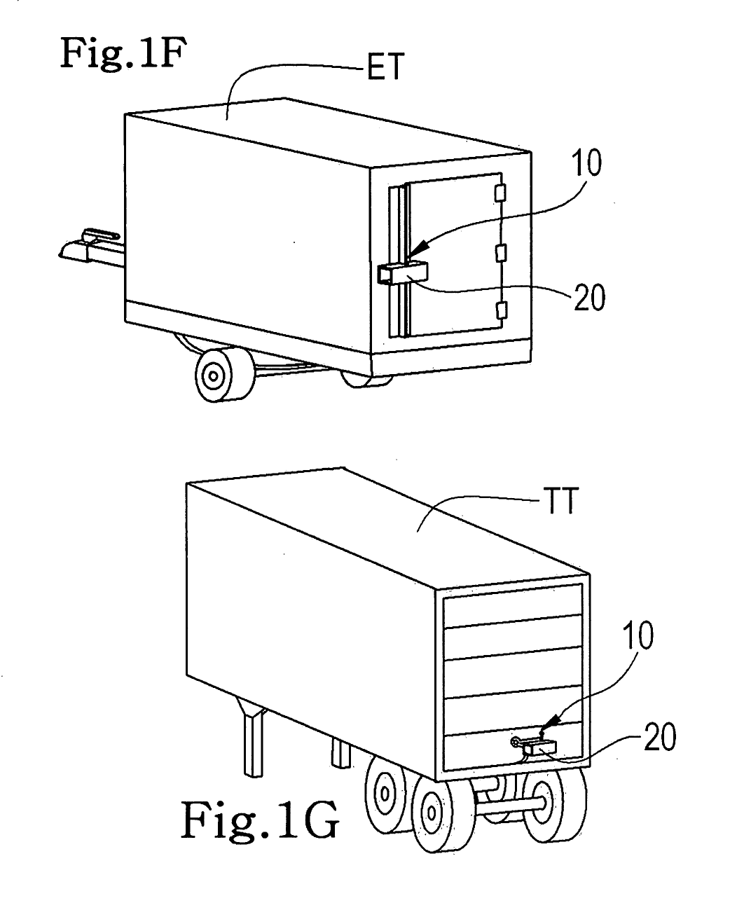

Referring generally to FIGS. 1A, 1B, 1C, 1D, and 1E, a receptacle or container, such as a trailer or a truck can contain valuable goods which are a temptation to thieves. To deter theft, it is quite common to secure the contents with a padlock, or other lock. In typical implementations, the invention comprehends a rigid and durable enclosure which is adapted and configured to generally surround, encapsulate, envelope, contain, and/or otherwise enclose the padlock or other lock. By enclosing the lock, and due at least in part to the characteristics of the device, various lock protectors of the invention mechanically restrict access to e.g. the padlock, shackle lock, other lock, hasp, trailer latch, trailer clasp, trailer tongue, receiver hitch, or receiver pin, as desired.

Correspondingly, the present invention deters theft of objects, articles, or items which are typically secured, at least in part by, for example, a padlock or other suitable shackling device, when used in combination with a lock protector of the invention. Thus, lock protectors of the invention represent a second layer of security for protecting the contained goods, or for protecting the receptacle, itself, whereby the lock protector provides security for the primary security device, which is a lock.

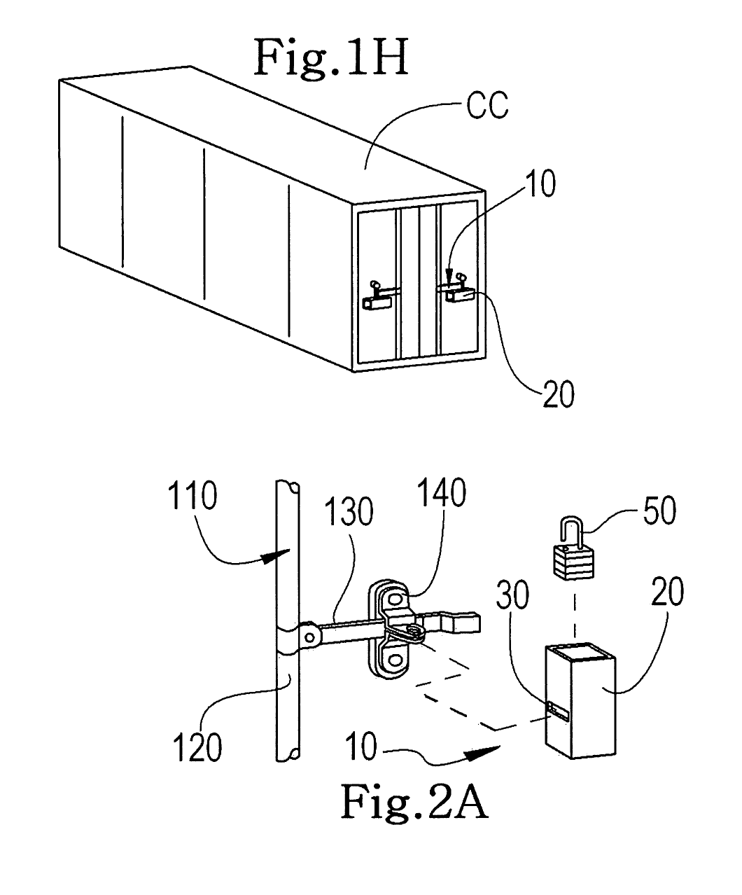

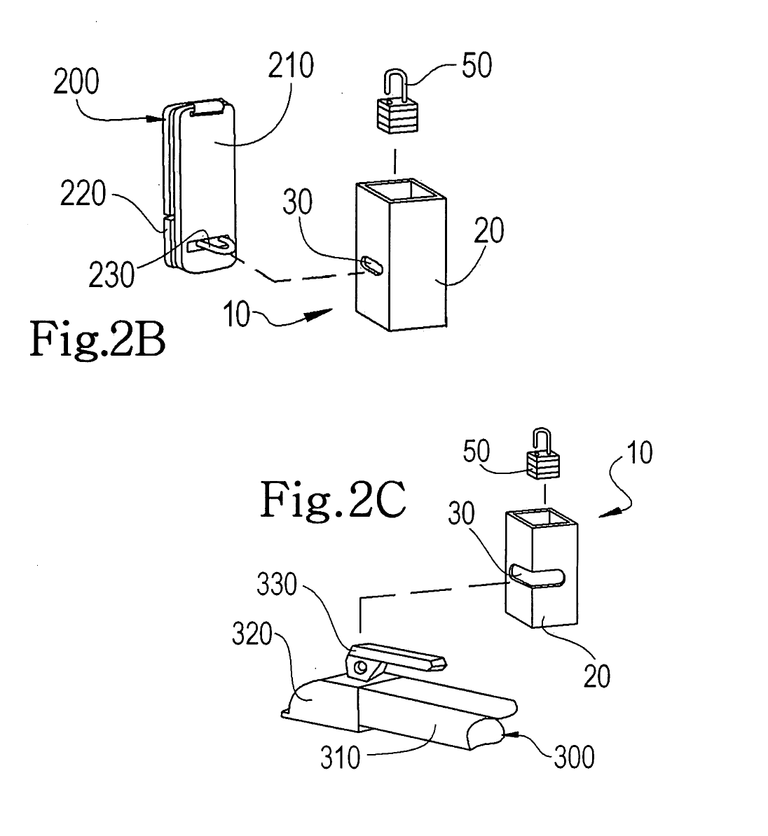

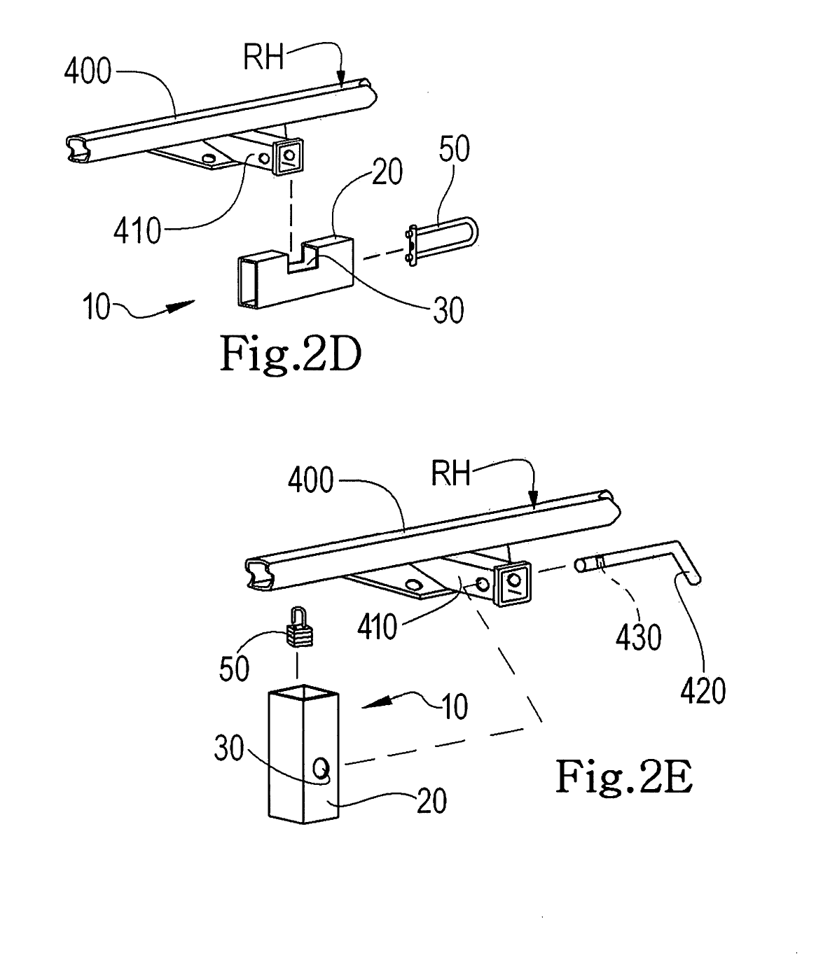

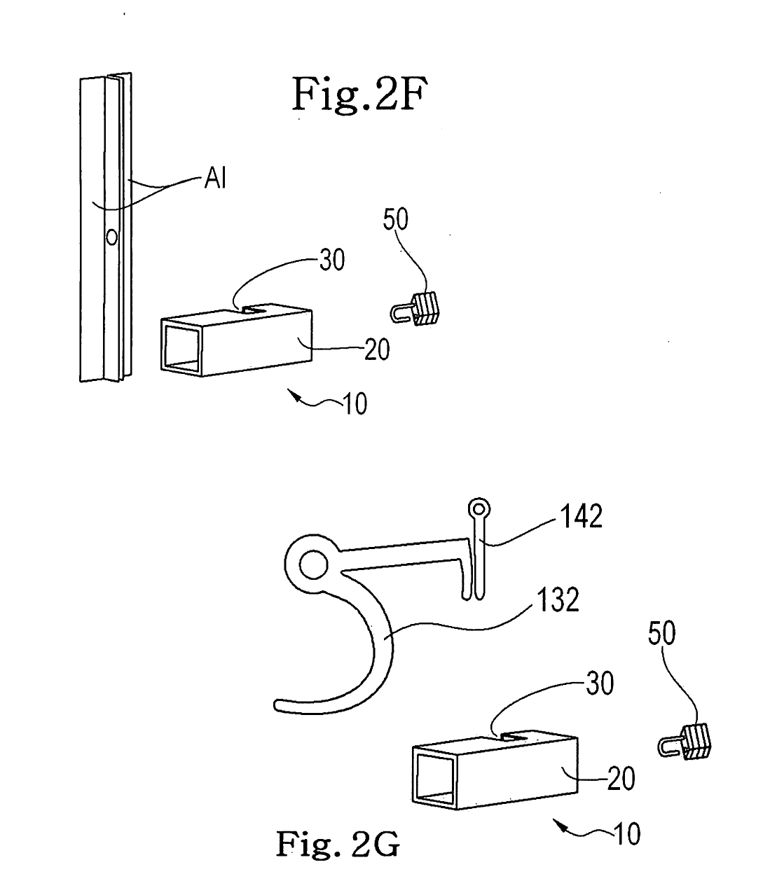

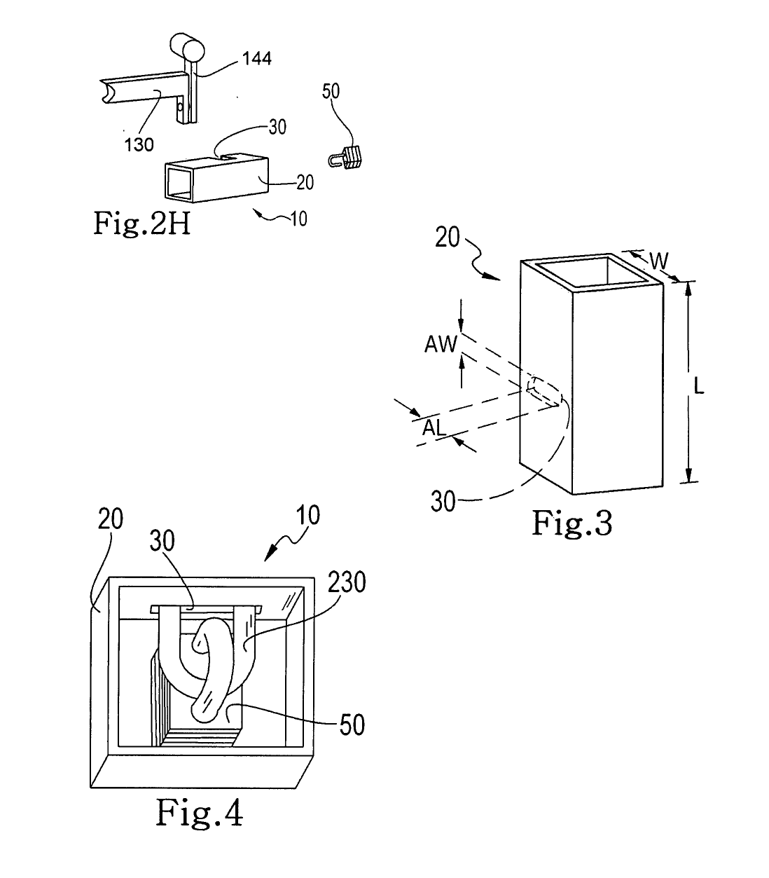

Lock protector assembly 10 includes lock protector 20 and lock 50 (FIGS. 1D, 2A, 2B, 2C, 2D, and 2E). Generally, lock 50 secures and/or locks some device or article thereby preventing easy access to the locked device or article. To protect such lock 50 from e.g. tampering, in the complete assemblage of lock protector assembly 10, lock protector 20 substantially limits access to lock 50 and/or various components thereof.

The various embodiments of lock protector assemblies 10 are e.g. sized, adapted, and configured for the particular use environment and to suitably cooperate with the intended corresponding hardware and/or devices and/or articles which are being secured. Namely, ones of the embodiments of lock protector assemblies 10 are adapted and configured for use with e.g. (i) cam-lock mechanisms 110 of tractor trailers “TT” (FIG. 1A), (ii) hasp-lock mechanisms of enclosed trailers “ET” (FIG. 1B), (iii) trailer coupling mechanisms “CM” (FIG. 1C), (iv) receiver hitches “RH” (FIG. 1D), (v) receiver hitch pins “HP” (FIG. 1E), and/or other uses of e.g. conventional or other locks.

Referring now to FIGS. 2A, 2B, 2C, 2D, 2E, 3, and 4, lock protector 20 includes a generally rigid and/or resilient body which is made from material(s) suitable for tamper resistant or security applications.

Lock protector 20 is elongate and has first and second ends. An opening extends into each of the first and second ends. Each of the first and second end openings extends and opens into a void or cavity.

As illustrated, lock protector 20 includes a plurality of sidewalls. Each of the sidewalls is generally planar and rectangular in perimeter. The lateral edges of adjacent sidewalls are joined to each other, whereby the resultant structure defines a generally continuous outer perimeter.

In the illustrated embodiments, the cross-sections of the lock protectors 20 are generally rectangular, some being square, in cross-section. However, other cross sectional configurations are contemplated and well within the scope of the invention including, but not limited to, triangular cross-section configurations, other polygonal cross-section configurations, circular and/or other cross-sectional configurations. In other words, yet other embodiments are suitable and well within the scope of the invention, so long as the relative dimension of e.g. the inner cavity of lock protector 20, the shape and size of the lock closure 20 end openings, the size and/or other characteristics of lock 50, and the size and/or other characteristics of the hardware or device which is secured by lock 50, correspond to enable suitable use characteristics of the end device.

Ones of the sidewalls of lock protector 20 include an aperture(s) extending therethrough, namely aperture 30. Aperture 30 is sized, configured, and located upon lock protector 20, based at least in part on the particular intended end use of lock protector assembly 10.

Generally, aperture 30 defines an aperture length “AL” and an aperture width “AW” (FIG. 3). Accordingly, lock protectors 20 which fit over relatively larger devices and/or hardware include apertures with relatively larger magnitudes of aperture length “AL” and width “AW”, while lock protectors 20 which fit over relatively smaller devices and/or hardware include apertures with relatively lesser magnitudes of aperture length “AL” and width “AW”. Thus, an aperture 30 which is adapted and configured to receive at least a portion of a receiver hitch (FIG. 2D) has a larger opening width and a larger opening length, illustrated as extending across at least parts of three adjacent sidewalls, than an aperture 30 that is adapted and configured to receive a hasp-lock staple (FIG. 2B).

The perimeter shapes of particular apertures 30 are also adapted and configured for rather specific end uses. In preferred embodiments, the shape of aperture 30 corresponds closely to the outer perimeter shape of the device or hardware which is covered by the respective enclosure 20. Also, the size of aperture 30 is preferably only slightly larger than, namely is closely configured to, the outer dimensions of the device or hardware which it covers, to provide adequate clearance for suitably easy insertion yet close enough in configuration to provide a snug fit to the device thereby preventing effective access to the hasp of lock 50.

Thus, the dimensions “AW” are limited in magnitude in order to thereby limit unauthorized access to the hasp of lock 50. The length dimension “AL” extends transverse to the length dimension “L” of enclosure 20. The magnitude of aperture dimension “AW” is substantially smaller than the length “L” of the enclosure. The aperture 30 in the one or more side walls which are penetrated are only large enough to comfortably receive the closure element or elements to be locked. The remainder portions of the respective one or more side walls which are penetrated by aperture 30 are generally closed, sufficient to preclude manipulation of the lock so as to damage, destroy, or otherwise compromise the effectiveness of lock 50.

To use lock protector 20, as part of lock protector assemblies 10, the user slides aperture 30 over the device or hardware to be secured. Then, the user slides lock 50 through one of the open ends of lock protector 20. Next, the user manually manipulates lock 50, through at least one, and at times both, end openings of lock protector 20 so as to fasten lock 50 to the desired device or hardware.

Aperture 30, is located upon lock protector 20 such that, in the complete assemblage 10, the keyhole portion of lock 50, typically the bottom, is adjacent one of the enclosure openings. Specifically, the bottom of lock 50 is near enough the respective opening to enable a user to suitably insert a key into the lock keyhole and unlock lock 50 as desired. The other enclosure opening is, for example, relatively distal lock 50 which makes it relatively more difficult for individuals to access the hardened shackle of lock 50 with e.g. tools. intended to break or cut the lock.

Referring now to FIGS. 1A and 2A, at least one embodiment of lock protector assemblies 10 is particularly well suited for use in the trucking industry. Trailer “TT” is a typical, two-door tractor trailer. Namely, trailer “TT” is an enclosed semi-truck trailer with two adjacent swinging doors, hingedly attached to the trailer compartment at the outer lateral edges thereof, the doors being secured by way of cam lock mechanisms 110.

In the entire assemblage of lock protector assembly 10, lock 50 (FIG. 2A) directly secures the cam lock mechanism 110. Lock 50 is encased by lock protector 20, masking it from view and providing a physical barrier thereto, when used with tractor trailer “TT.”

Cam lock 110 includes an actuatable handle, e.g. locking arm 130, which is pivotably attached to an upright pivot bar 120. Pivot bar 120 is restrained by way of, for example, mounting brackets, to pivotable or rotational movement about its axis. Accordingly, to pivot or rotate pivot bar 120, a user applies a force to locking arm 130 in the direction of intended pivotation.

Pivot bar 120 is mounted to a door of the tractor trailer. The lower end of pivot bar 120 includes a cam-type device (not illustrated) which is adapted and configured to cooperatively interface with a cam receiving bracket. The cam receiving bracket is mounted to the trailer bed at a suitable location to receive the cam when the trailer door is closed.

The cam of pivot bar 120 and the cam receiving bracket cooperate such that when locking arm 130 and thus the cam are in a first position, relatively distal the trailer door, the cam is not locked into the cam receiving bracket and is thus generally free to move with respect thereto. When locking arm 130 is in a second position, relatively proximate the trailer door as illustrated in FIGS. 1A, 2A, the cam interfaces with the cam receiving bracket which relatively tightly urges the trailer door closed, against the respective door frame.

Lock clasp 144 is adapted and configured to mechanically capture locking arm 130 so as to selectively fix the handle in position, proximate the trailer door, thus locking the trailer door in the closed position. Namely, lock clasp 144 includes a handle hasp, as a lower, fixed and outwardly extending bracket, and a handle keeper, as an upper, pivotable bracket. Each of the handle hasp and handle keeper has a bore, which are registered to and in coaxial alignment with each other, which enables a user to pass a padlock, shackle lock, and/or other lock through the handle hasp and handle keeper and thus secure handle 130 generally against the trailer door.

To use lock protector 20 with a cam-lock device, a user closes the tractor trailer door, secures the door handle with lock clasp 144, and inserts lock clasp 144 through aperture 30 of enclosure 20. Then the user slides lock 50 through one of the open ends of lock protector 20 and inserts the lock shackle through the bores in the handle hasp and handle keeper of clasp 144. Next, the user manually manipulates lock 50, using at least one end opening of lock protector 20 so as to close lock 50 onto the lock clasp 144.

Referring now to FIGS. 1B and 2B, lock protector assembly 10 is adapted and configured for use in e.g. the recreational trailer industry, building or other structure security industries, and/or other suitable applications which use, for example, hasp locks.

Exemplary of such embodiments, enclosed trailer “ET”, is e.g. a snowmobile or other enclosed trailer and includes lock protector assembly 10. The cover/lid of enclosed trailer “ET” is hingedly or otherwise liftingly attached to the trailer bed. A hasp 200 (FIG. 2B) and lock 50 secure the cover/lid in the downward, closed, position. In use, lock protector 20 masks the lock from view and provides a physical barrier thereto.

Hasp 200 generally includes hinged body 210 and staple plate 220. Hinged body 210 has first and second generally planar, rigid, portions which are hingedly attached to each other at respective ends. The first, relatively shorter, portion attaches to e.g. the cover/lid of enclosed trailer “ET” and the second, relatively longer, portion is hingedly attached to the first portion and has an aperture which extends therethrough.

Staple plate 220 is a generally planar structure which is attached to e.g. an outer surface of the trailer bed. Staple 230 extends outwardly from the staple plate and is adapted and configured to extend through the hinged body 210 aperture when the second hinged body portion hinges downwardly, covering the first hinged body portion.

Lock 50, as previously indicated, can be any suitable lock e.g. a padlock, shackle lock, and/or other lock, and passes through staple 230 and thus secures the hinged body 210 to the staple plate. In other words, in the general process of locking the cover/lid of enclosed trailer “ET” in the downward, closed, position, a user folds or hingedly pivots the second part of hinged body 210 over the staple plate such that staple 230 passes through the hinged body aperture. Then, the user secures the trailer cover/lid to the trailer bed by locking lock 50 upon staple 230 which prevents hinged body 210 from being pivotably withdrawn away from staple plate 220, whereby the trailer cover/lid is temporarily secured to the remainder of the trailer.

Specifically, to use lock protector 20 of FIG. 2B with a hasp lock device, a user inserts staple 230 through aperture 30 of the lock protector. Then the user slides lock 50 through one of the open ends of lock protector 20 and inserts the lock shackle through staple 230. Next, the user manually manipulates lock 50, through at least one end opening of lock protector 20 so as to close lock 50 onto the hasp 200.

Referring now to FIGS. 1C and 2C, lock protector assembly 10 is adapted and configured to provide added security for the point of attachment between trailers and tow vehicles. In short, lock protector 20 masks from view and provides a physical barrier to a lock which secures a trailer coupling mechanism to its respective tow vehicle.

Trailer tongue assembly 300 includes an elongate tongue member 310 which is typically made from a tubular metallic material. The tongue member 310 is attached to the trailer body at one end and at the other end it is attached to a coupler mechanism e.g. coupler 320. Coupler 320 is adapted and configured to cooperate with a towing ball, attached to a tow vehicle, and selectively couple the trailer thereto.

Lock lever 330 actuates the coupler collar or fork (not illustrated) which communicates with the relatively lesser diameter portion(s) of the towing ball and generally prevents the towing ball from withdrawing from the coupler cavity. Stated in other terms, in a first, upward position, lock lever 330 actuates the coupler collar or fork so as to prevent the towing ball from entering or being withdrawn from the coupler cavity. In a second, downward position, lock lever 330 actuates the coupler collar or fork so as to prevent the towing ball from entering or being withdrawn from the coupler cavity. Lock lever 330 includes a through bore which is registered with another through bore of a stationary plate within the coupler assembly.

By mounting lock 50 through the registered holes of lock lever 330 when lock lever 330 is in the downward position, and closing the lock, a user lockingly secures the lever in such downward position, whereby the trailer coupler 320 is secured to the tow vehicle.

In a lock protector 20 used with a lever locking trailer tongue device, aperture 30 spans two adjacent side walls of the enclosure. A user inserts lock lever 330 through aperture 30 of the lock protector. Then the user slides lock 50 through one of the open ends of lock protector 20 and inserts the lock shackle through lock lever 330. Next, the user manually manipulates lock 50, through at least one end opening of lock protector 20 so as to close lock 50 onto the lock lever 330.

Referring now to FIGS. 1D and 2D, some embodiments of lock protector assemblies 10 are adapted and configured to provide security for the connection between a receiver hitch “RH” and a receiver ball mount (not illustrated). The embodiment of FIG. 2D utilizes a U-lock 50 in lieu of a receiver hitch pin. Lock protector 20 masks the U-lock from view and provides a physical barrier thereto.

Receiver hitch “RH” includes an elongate, preferably metallic tubing, cross member 400 and receiver tubing 410 extending outwardly therefrom. Receiver tubing 410 has an opening at a first end which opens into a receiver cavity. The outer, lateral, sidewalls of receiver tubing 410 have coaxially aligned through bores extending through the respective thicknesses thereof.

When in use, the receiver ball mount slidingly inserts into the receiver tubing cavity. A bore which extends through a neck portion of the receiver ball mount is aligned with the receiver sidewall bores. U-lock 50 extends through the receiver sidewall bores and the receiver ball mount bore, thus locking the ball mount into the receiver.

In a lock protector 20 used with a U-lock equipped receiver hitch, aperture 30 spans three adjacent side walls of the enclosure. A user mounts aperture 30 of the lock protector over receiver tubing 410. Then the user slides U-lock 50 through one of the open ends of lock protector 20 and inserts the U-lock through the receiver tubing sidewall bores. Next, the user manually manipulates U-lock 50, through at least one end opening of lock protector 20 so as to close U-lock 50 onto the receiver hitch.

Referring now to FIGS. 1E and 2E, some embodiments of lock protector assemblies 10 are adapted and configured to provide security for the connection between a receiver hitch “RH” and a receiver ball mount specifically by providing means for securing a receiver pin 420 to receiver tubing 410. Lock protector 20 masks the lock and the end of the receiver pin from view and provides a physical barrier thereto.

Receiver pin 420 is similar to a typical receiver pin in that it is an elongate piece of e.g. hardened steel with an elbow bent thereinto. The end of pin 420 which is inserted through receiver tubing 410 includes a through bore which extends radially through the pin, namely bore 430. In general, to lockingly secure pin 410 to receiver hitch “RH,” a user inserts the hardened shackle of lock 50 through bore 430 and locks lock 50 to pin 420.

Access aperture 30 is circular, just large enough in cross-section to receive pin 420. As with all the embodiments illustrated herein, the effective width “AW” of aperture 30 in FIG. 2E is substantially smaller than the length “L” of enclosure 20.

To use lock protector 20 with receiver pin 420, a user inserts the end of the receiver pin through the apertures in the side walls of receiver tubing 410, and slides aperture 30 of the lock protector over the end of the pin. Then the user slides lock 50 through one of the open ends of lock protector 20 and inserts the lock shackle through bore 430 of the pin. Next, the user manually manipulates lock 50, through at least one end opening of lock protector 20 so as to close lock 50 onto the receiver pin 420.

Referring now to FIGS. 1F and 2F, some enclosed trailers, for example enclosed utility trailers, include various mechanical locking devices. The utility trailer illustrated in FIG. 1F has a single door mounted on a set of hinges so as to swing about an upright axis. A lock protector assembly 10 cooperates with first and second angle irons “AI”.

Namely, the utility trailer includes a first vertically-extending elongate piece of angle iron “AI” mounted to the door, adjacent the lateral door edge which is most distal the door hinge(s). The utility trailer further includes a second elongate piece of angle iron “AI” which extends generally vertically, mounted upon the trailer back-wall, adjacent the door opening and extending vertically, adjacent the first elongate pieces of angle iron. Accordingly, when the trailer door is closed, the first and second pieces of angle iron “AI” are proximate each other. In other words, vertically-extending portions of the respective angle iron members which extend perpendicularly away from the trailer are in face to face communication with each other when the trailer door is closed. Also, each of these perpendicularly outwardly extending portions has a bore extending therethrough. The bores of the angle iron members are registered with each other, which enables a user to pass a lock shackle through both bores, locking the two angle iron members “AI” to each other.

As with the embodiments of FIGS. 1D, 2D, aperture 30 spans three adjacent side walls of enclosure 20. To use lock protector 20 with such multiple angle iron member door lock device, a user first closes such door and mounts aperture 30 of the lock protector over the outwardly extending portions of the angle iron members, such that the angle iron bores are within the enclosure cavity. Next, the user slides e.g. lock 50 into lock protector 20 and slides the lock hasp through the first and second bores of the first and second angle iron members “AI”, respectively. The user then manually manipulates lock 50, through at least one end opening of lock protector 20 so as to close lock 50 onto the angle iron members.

Referring now to FIGS. 1G and 2G, some semi-trailers, cube trailers, and/or other trailers, as well as, for example, moving trucks and vans, and/or other enclosed trucks, include lift-type doors in lieu of the swing-type doors illustrated in FIG. 1A.

Typical trailer or truck lift-type doors include a hook-type latch mechanism, exemplarily illustrated in FIG. 2G. Such hook-type latch mechanism includes a pivotable member 132 which has a generally arcuate portion and a generally straight handle portion. Such hook-type latch mechanism further includes a latch finger 142. To operate the device, the user closes the door then actuates the pivotable member 132 by applying a force to the handle portion thereof.

In so doing, the generally arcuate portion extends through an opening of and mechanically interfaces with e.g. a rigid cross member which is fixedly attached, directly or indirectly, to the vehicle or trailer frame or chassis. This mechanical interfacing relationship between the hook-type latch mechanism and the cross member forces the door snugly down against the e.g. trailer or truck bed, thus latching the door to the trailer or truck bed.

Once the handle is sufficiently pivoted downwardly, a projection at its distal end is adjacent the latch finger 142. Coaxially aligned bores (not shown) extend through facing portions of each of the handle end projection and latch finger 142, which enables a user to insert e.g. a lock shackle therethrough and thus secure the pivotable member 132 in a generally fixed position and accordingly lock the door in its downward position.

Aperture 30 spans two or three side walls of enclosure 20, depending on the locations of the bores through the latch handle and latch finger 142. To use lock protector 20 with such hook-type latch mechanism, a user first closes the door and rotates the latch, thus securing the door. The user then inserts the handle end projection and a portion of latch finger 142 through aperture 30 of the lock protector, such that the latch mechanism bores are within the enclosure cavity. Next, the user slides lock 50 into lock protector 20 and through the latch mechanism bores. The user then manually manipulates lock 50, through at least one end opening of lock protector 20 so as to close lock 50 onto the hook-type latch mechanism.

Referring now to FIGS. 1H and 2H, in some embodiments, lock protector assembly 10 is used in combination with, for example, cargo containers, shipping containers, and/or other enclosures which can be e.g. mounted on a mobile chassis for transport as desired.

Typical cargo or shipping containers include cam-lock mechanisms similar to that illustrated on the semi tractor trailer of FIG. 1A. However, FIGS. 1H and 2H show different embodiments of locking arms and lock clasps, as compared to those of FIG. 1A and 2A.

Namely, locking arm 130 includes a projection at the distal end of its handle portion and the lock clasp 144 is a finger like projection. Coaxially aligned bores extend through each of the handle end projection and finger like lock clasp 144, which enables a user to insert e.g. a lock shackle through the aligned bores and thus secure the doors by way of the cam-lock mechanism.

Aperture 30 spans at least two, optionally three, of the side walls of enclosure 20, depending on the lengths of locking arm 130 and lock 144 below the bores.

To use lock protector 20 with this second type of cam-lock mechanism, a user closes the doors, suitably manipulates the lock arm 130 to close the door, and mounts aperture 30 of the lock protector over the handle end projection and a portion of lock clasp 142, such that the through bores are within the enclosure cavity. Next, the user slides lock 50 into lock protector 20 and through the through bores. The user then manually manipulates lock 50, through at least one end opening of lock protector 20 so as to close lock 50 onto the hook-type latch mechanism.

Referring now to FIGS. 3 and 4, in some embodiments, the relative dimensions of the outside of lock 50 and the inner surface of lock protector 20 correspond such that lock 50 is housed in the enclosure in a relatively close manner, whereby lock 50 does not completely freely rotate or swing within the enclosure. Thus the relative dimensional characteristics of the various components of lock protector assembly 10 generally mitigate the need for a user to reach into one enclosure end opening to steady or otherwise hold lock 50 while manipulating, such as unlocking, lock 50 by way of the other enclosure end opening.

Specifically regarding the sizes and dimensions of some exemplary embodiments, in some embodiments, lock protector 20 is made from two-inch by two-inch square steel tubing, with a one-sixteenth inch sidewall thickness. Accordingly, the cavity width of such embodiments is about one and seven-eighths inch between the inwardly facing sidewall surfaces. The padlock used with such embodiment is preferably sized such that the lock can be slid axially into enclosure 20, yet is generally restrained from complete rotational travel within the enclosure.

In some embodiments, the length of lock protector 20 is about 4.75 inches, optionally longer or shorter. In e.g. the 4.75 inches long embodiments, the center of aperture 30 is about 2.75 inches from one of the enclosure 20 ends, optionally located medially or otherwise upon the enclosure.

As one example, for embodiments adapted and configured for cam lock applications, e.g. tractor trailer applications, aperture 30 is about 0.34 inch wide and about 1.6 inches long, or otherwise as required for suitable use and functionality in a particular intended cam lock application.

As another example, for embodiments adapted and configured for hasp lock applications, aperture 30 is about 0.38 inch wide and about 1.13 inches long, or otherwise as required for suitable use and functionality in a particular intended hasp lock application.

While the side walls of enclosure 20 have been illustrated as being generally planar and rectangular, the side walls can be represented by curved surfaces, as well. Thus, enclosure 20 can be defined by a tube having a circular or oval cross-section. In such instance, enclosure 20 has a single side wall which extends about the entire perimeter of the enclosure.

In some embodiments, lock protector 20 further includes at least one end cover (not illustrated). The end covers are adapted and configured to generally close the openings at the respective ends of enclosure 20. Correspondingly, the covers mitigate the amount of e.g. rain, snow, and/or other elements which can enter enclosure 20 via the end openings. Also, the covers mitigate e.g. the frequency of entrance by insects, vermin, and/or other non-desired entities, into enclosure 20 via the end openings.

As one example, the end covers are pivotably, optionally laterally slidably, attached to the ends of enclosure 20. In such embodiments, the user does not remove the end covers to operate lock protector 20. Rather, the user actuates the end covers to access the enclosure cavity as desired.

As another example, the end covers are removably attached to the ends of lock protector 20. Such removable attachment can be effectuated by way of e.g. a sliding relationship between the cover and the end portion of enclosure 20. Exemplary end cover structures include, but are not limited to, a plastic or rubber boot-type structure as a cover which slides over and outside of the outer perimeter surface of the enclosure end(s). Alternatively, the cover can be a plug-type structure which slides into the opening itself and interfaces with, for example, the inner circumferential surface of the end of the enclosure.

Preferably, lock protector assembly 10 is made of materials which are suitably strong and durable for normal extended use. Those skilled in the art are well aware of certain metallic and non-metallic materials which possess such desirable qualities, and appropriate methods of forming such materials.

Appropriate metallic materials for various components of lock protector assembly 10 include, but are not limited to, aluminum, steel, stainless steel, titanium, magnesium, brass, and their respective alloys. Common industry methods of forming such metallic materials include casting, forging, shearing, bending, machining, riveting, welding, powdered metal processing, extruding and others.

Non-metallic materials suitable for components of lock protector assembly 10, e.g. the enclosure end covers, and others, are various polymeric compounds, such as for example and without limitation, various of the polyolefins, such as a variety of the polyethylenes, e.g. high density polyethylene, or polypropylenes. There can also be mentioned as examples such polymers as polyvinyl chloride and chlorinated polyvinyl chloride copolymers, various of the polyamides, polycarbonates, and others.

For any polymeric material employed in structures of the invention, any conventional additive package can be included such as, for example and without limitation, slip agents, anti-block agents, release agents, anti-oxidants, fillers, and plasticizers, to control e.g. processing of the polymeric material as well as to stabilize and/or otherwise control the properties of the finished processed product, also to control hardness, bending resistance, and the like.

Common industry methods of forming such polymeric compounds will suffice to form non-metallic components of lock protector assembly 10. Exemplary, but not limiting, of such processes are the various commonly-known plastics converting processes.

Those skilled in the art will now see that certain modifications can be made to the apparatus and methods herein disclosed with respect to the illustrated embodiments, without departing from the spirit of the instant invention. And while the invention has been described above with respect to the preferred embodiments, it will be understood that the invention is adapted to numerous rearrangements, modifications, and alterations, and all such arrangements, modifications, and alterations are intended to be within the scope of the appended claims.

To the extent the following claims use means plus function language, it is not meant to include there, or in the instant specification, anything not structurally equivalent to what is shown in the embodiments disclosed in the specification.

Having thus described the invention, what is claimed is:

1. A lock protector device, comprising:
(a) one or more sidewalls which collectively define an outer surface, and first and second ends of said lock protector device, and a length (L) of said lock protector device between the first and second ends; and
(b) at least a first opening which extends into the first end of said lock protector device and which opens into a cavity extending axially into said lock protector device;
said one or more sidewalls defining a limited-size access aperture (30) having a length dimension (AL) extending transverse to the length dimension (L) of said lock protector device, and a width dimension (AW) substantially smaller than the length dimension (L) of said lock protector device.

2. A lock protector device as in claim 1 wherein said one or more side walls define a generally closed perimeter of said lock protector device.

3. A lock protector assembly kit comprising a lock protector device as in claim 1, further comprising a lock, said lock having a lock body, and a shackle extending from said lock body, said shackle and said lock protector device being adapted and configured such that said shackle can be received into the cavity in said lock protector device through the first opening which extends into the first end of said lock protector device so as to protect said shackle from effective application of manually-actuated cutting tools.

4. A lock protector device as in claim 1 wherein said limited-size access aperture spans at least first and second adjacent ones of said one or more side walls.

5. A lock protector device as in claim 1 wherein said limited size access aperture comprises a generally circular opening spaced from both of the first and second ends.

6. A lock protector device as in claim 1, further comprising a second opening which extends into the second end of said lock protector device and which opens into the cavity.

7. A locked receptacle, comprising
(i) a receptacle closed by closure structure, thereby blocking intended-use access to said receptacle,
(ii) a lock, said lock comprising a lock body, and a shackle extending from said lock body, said lock locking such closure structure in such closed condition, and
(iii) a lock protector as in claim 1 extending about said lock and interfering with access to said shackle by hand tools commonly useful for defeating such lock shackle.

8. A lock protector device, comprising:
(a) at least first and second sidewalls, each having a thickness dimension, intersecting at respective edges thereof, said at least first and second sidewalls collectively defining an outer surface of said lock protector, and first and second ends of said lock protector, and a length (L) of said lock protector between the first and second ends; and
(b) a limited-size access aperture (30) which extends, transverse to the length (L) of said lock protector, across a portion of at least two adjacent ones of said sidewalls, the aperture (30) extending through the entire thickness dimension of the respective said at least two adjacent ones of said sidewalls.

9. A lock protector device as in claim 8 wherein said one or more side walls define a generally closed perimeter of said lock protector device.

10. A lock protector assembly kit comprising a lock protector device as in claim 8, further comprising a lock, said lock having a lock body, and a shackle extending from said lock body, said shackle and said lock protector device being adapted and configured such that said shackle can be received into the cavity in said lock protector device through the first opening which extends into the first end of said lock protector device so as to protect said shackle from effective application of manually-actuated cutting tools.

11. A lock protector device as in claim 8 wherein said limited size access aperture comprises a generally circular opening spaced from both of the first and second ends.

12. A lock protector device as in claim 8, further comprising a second opening which extends into the second end of said lock protector device and which opens into the cavity.

13. A locked receptacle, comprising
(i) a receptacle closed by closure structure, thereby blocking intended-use access to said receptacle,
(ii) a lock, said lock comprising a lock body, and a shackle extending from said lock body, said lock locking such closure structure in such closed condition, and
(iii) a lock protector as in claim 8 extending about said lock and interfering with access to said shackle by hand tools commonly useful for defeating such lock shackle.

14. A lock protector assembly, comprising:
(a) a lock protector comprising
(i) one or more sidewalls which collectively define a side wall perimeter of said lock protector structure, said lock protector structure being generally closed along the side wall perimeter and having first and second open ends,
(ii) an aperture (30) extending through at least one of said one or more sidewalls and being displaced from the first end of said enclosure structure by a first distance; and
(b) a lock having a lock body, and a shackle length dimension extending away from said lock body,
wherein the magnitude of the first distance, between the aperture and the first end of the enclosure structure, is greater than the shackle length dimension extending away from said lock body.

15. A lock protector device as in claim 14 wherein said one or more side walls define a generally closed perimeter of said lock protector device.

16. A lock protector device as in claim 14 wherein said limited-size access aperture spans at least first and second adjacent ones of said one or more side walls.

17. A lock protector device as in claim 14 wherein said limited size access aperture comprises a generally circular opening spaced from both of the first and second ends.

18. A lock protector device as in claim 14, further comprising a second opening which extends into the second end of said lock protector device and which opens into the cavity.

19. A locked receptacle, comprising
(i) a receptacle closed by closure structure, thereby blocking intended-use access to said receptacle,
(ii) a lock, said lock comprising a lock body, and a shackle extending from said lock body, said lock locking such closure structure in such closed condition, and
(iii) a lock protector as in claim 14 extending about said lock and interfering with access to said shackle by hand tools commonly useful for defeating such lock shackle.

20. A lock protector device, comprising:
(a) one or more sidewalls which collectively define a lock protector having a sidewall perimeter, said enclosure structure being generally closed along the sidewall perimeter and having at least a first open end; and
(b) an aperture extending through at least one of said one or more sidewalls, the aperture extending along a minor portion of a length dimension of a respective said sidewall and extending along a minor portion of a width dimension of the respective said sidewall.

21. A lock protector device as in claim 20 wherein the side wall perimeter is defined by a single circular side wall.

22. A lock protector device as in claim 20 wherein said one or more side walls define a generally closed perimeter of said lock protector device.

23. A lock protector assembly kit comprising a lock protector device as in claim 20, further comprising a lock, said lock having a lock body, and a shackle extending from said lock body, said shackle and said lock protector device being adapted and configured such that said shackle can be received into the cavity in said lock protector device through the first opening which extends into the first end of said lock protector device so as to protect said shackle from effective application of manually-actuated cutting tools.

24. A lock protector device as in claim 20 wherein said limited-size access aperture spans at least first and second adjacent ones of said one or more side walls.

25. A lock protector device as in claim 20 wherein said limited size access aperture comprises a generally circular opening spaced from both of the first and second ends.

26. A lock protector device as in claim 20, further comprising a second opening which extends into the second end of said lock protector device and which opens into the cavity.

27. A locked receptacle, comprising
(i) a receptacle closed by closure structure, thereby blocking intended-use access to said receptacle,
(ii) a lock, said lock comprising a lock body, and a shackle extending from said lock body, said lock locking the closure structure in such closed condition, and
(iii) a lock protector as in claim 20 extending about said lock and interfering with access to said shackle by hand tools commonly useful for defeating such lock shackle.
